(19) United States
(12) Patent Application Publication
(10) Pub. No.: US 2016/0096718 A1
(43) Pub. Date: Apr. 7, 2016

(54) PAINT CAN DISPENSER ASSEMBLY

(71) Applicant: Arigala Painting, Inc., Castaic, CA (US)

(72) Inventor: Jose Antonio Gallardo, Castaic, CA (US)

(73) Assignee: ARIGALA PAINTING, INC., Castaic, CA (US)

(21) Appl. No.: 14/507,422

(22) Filed: Oct. 6, 2014

(51) Int. Cl. B67D 3/00; B01D 35/04; B65D 47/06

(52) U.S. Cl. CPC B67D 3/0061; B65D 47/06; B01D 35/04; B65D 2547/066

(57) ABSTRACT

A paint can dispenser assembly includes a lid removably attachable to an open end of a paint can. A spigot extends from the lid so as to be in fluid communication with the paint within the paint can for controllably pouring the paint from the can. A filter is associated with the lid for filtering the paint before it passes through the spigot.

### BACKGROUND OF THE INVENTION

The present invention generally relates to replacement lids for paint cans. More particularly, the present invention relates to a paint can dispenser assembly which filters the paint and allows controlled pouring of the paint from the can.

Paint and stains are typically offered in manufactured containers, typically one gallon containers comprised of metal and in some cases plastic. Paint and stains are also offered in larger containers, such as five gallon containers, as well as containers that are smaller than a gallon. However, one gallon containers of paint and stain are commonly used. After proper mixing, the lid from the paint container is removed and the paint is removed from the container in order to paint the walls or other objects. This may be done by dipping a paint brush directly into the container of paint or stain, pouring the paint or stain into another receptacle for dipping by a roller, paint brush, etc., or by using a pressurized sprayer.

There are several drawbacks associated with the manner in which paint and stains are currently dispensed from the container. Painters often apply paint or stain by dipping a brush and then wiping the excess paint or stain from the brush against the rim of the original paint container. This can cause an undesirable overflow onto the sides of the container, which often renders the product label unreadable. Many paint containers have a grooved rim which facilitates the airtight closure and removal of the container's lid. However, paint overflow, such as by dipping a brush and then swiping excess paint from the brush against the rim of the original paint container, can cause paint or stain to overflow and sometimes fill this groove. This requires the cleaning of the rim after painting as if the rim is not thoroughly cleaned after use it can become very difficult to reseal the container in an airtight manner with its original lid as the lid will not fit properly within the groove. This can result in the evaporation or deterioration of the paint or stain over time, requiring the discarding of partially empty paint containers.

Pouring paint from its original container to another container can also result in the paint or stain flowing over onto the label and within the grooved rim of the container, causing the problems indicated above.

Paint containers, and particularly previously opened paint containers, can contain impurities resulting from improper mixing, dried chips of paint, bristles from brushes dipped into the container, objects such as dirt or plant debris, or paint that has gelled or developed a layer of dried or partially dried skin thereon due to exposure to the air. These impurities and foreign objects can mar the surface or object being painted. Moreover, such objects can clog and render inoperable pressurized paint spray devices.

Accordingly, there is a continuing need for an assembly which prevents the overflow of paint or stain onto the exterior and rim of the original paint container. There is also a continuing need for such an assembly which allows the filtering of paint and stain as it is dispensed from the container. What is further needed is an assembly which provides a manner of controllably pouring the paint from the can. The present invention fulfills these needs, and provides other related advantages.

### SUMMARY OF THE INVENTION

The present invention resides in a paint can dispenser assembly which overcomes the drawbacks noted above. The paint can dispenser assembly of the present invention comprises a lid which is attachable to an open end of the paint can. The lid includes a peripheral rim that is configured for interference fit with a peripheral rim of the paint can, so as to sealingly attach the lid to an open end of the paint can.

The lid may include a lip that extends over an outer surface of the paint can adjacent to the open end thereof.

The lid may define a base having a well in fluid communication with the spigot.

A spigot extends from the lid so as to be in fluid communication with paint within the paint can for controllably pouring the paint from the can. The spigot may comprise a manually actuated lever or push button for selectively opening and closing the spigot such that the paint may be controllably poured from the can. The spigot may be removably attached to the lid.

A filter is associated with the lid for filtering the paint before it passes through the spigot. The filter may comprise an apertured hollow body extending from the lid generally opposite the spigot and into the paint can. A mesh material may at least partially surround the body. The mesh material may be removably attached to the body. Moreover, the body may be removably attached to the lid. The filter may comprise a sheet of mesh material, a portion of which is captured between a rim of the lid and a rim of the paint can.

The assembly may include a support for elevating the spigot and/or preventing the paint can dispenser assembly and attached paint can from rolling on a surface.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is an environmental perspective view of a paint can dispenser assembly of the present invention attached to a paint can;

FIG. 2 is a front elevational view of the paint can dispenser assembly and the paint can of FIG. 1;

FIG. 3 is a partially exploded view illustrating components of a paint can dispenser assembly embodying the present invention;

FIG. 4 is a partially exploded perspective view, similar to FIG. 3, illustrating a mesh filter positioned over a body of the assembly, in accordance with the present invention;

FIG. 5 is a front perspective view of the assembled paint can dispenser assembly embodying the present invention, without the mesh filter material;

FIG. 6 is a partially exploded perspective view of a paint can dispenser assembly embodying the present invention, illustrating a sheet of mesh material above a lid of the assembly;

FIG. 7 is a perspective environmental view, showing a paint can, in phantom, attached to the assembly of FIG. 6;

FIG. 8 is an enlarged front elevational view illustrating the interconnection of the paint can and the assembly of the present invention;

FIG. 9 is an enlarged cross-sectional view of area “9” of FIG. 8, illustrating the interconnection of the base lid, filter and paint can, in accordance with the present invention;

FIG. 10 is a partially exploded perspective view of another paint can dispenser assembly of the present invention, with a sheet of mesh material above a base lid of the assembly;

FIG. 11 is a perspective environmental view, illustrating a paint can attached to the assembly of FIG. 10;

FIG. 12 is an enlarged front elevational view, illustrating the interconnection between the assembly and the paint can; and

FIG. 13 is an enlarged cross-sectional view of area “13” of FIG. 12, illustrating the interconnection of the base lid, filter and paint can, in accordance with the present invention.

### DETAILED DESCRIPTION OF THE PREFERRED EMBODIMENTS

As shown in the accompanying drawings, for purposes of illustration, the present invention is directed to a paint can dispenser assembly. The paint can dispenser assembly of the present invention is designed and configured to filter paint as it is dispensed from the can.

As used herein, the term “paint” refers broadly to a variety of paints and stains which may be used to paint or stain interior walls or exterior walls of residential or commercial structures, or any other object. Moreover, the term “can” as used herein refers to the paint can or container in which the paint is offered by the manufacturer. The assembly of the present invention is particularly suited for use in connection with paint cans having a removable lid and a grooved rim. Such cans are often comprised of a metal material and can come in various sizes, including a gallon can, or cans which are less than a gallon or more than a gallon, such as a five-gallon can.

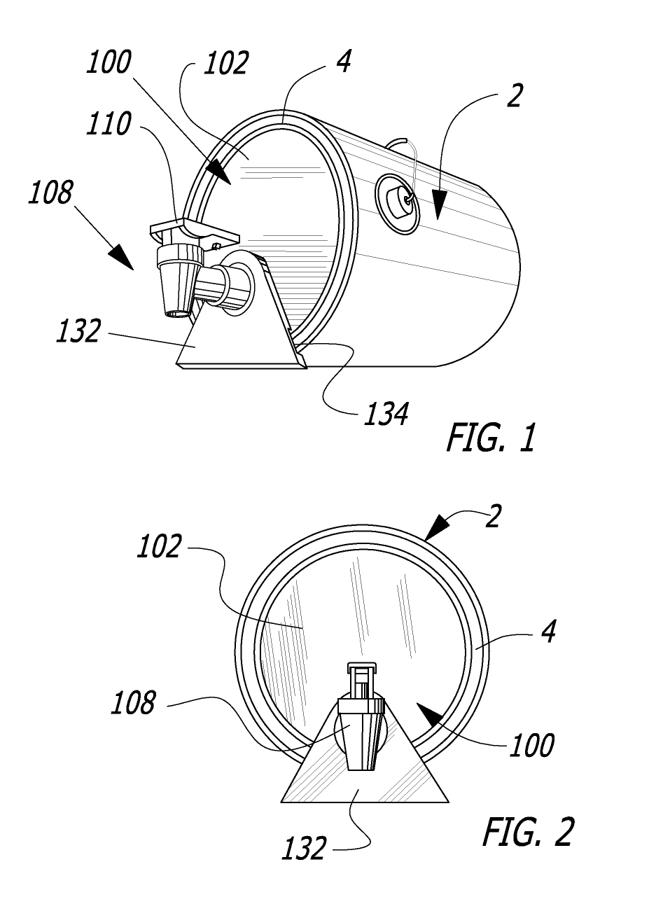

With reference now to FIGS. 1 and 2, a paint can dispenser assembly 100 embodying the present invention is shown operably attached to a paint can 2. In accordance with the present invention, the lid (not shown) of the paint can 2 is removed and the assembly 100 of the present invention is attached to an open end of the paint can 2.

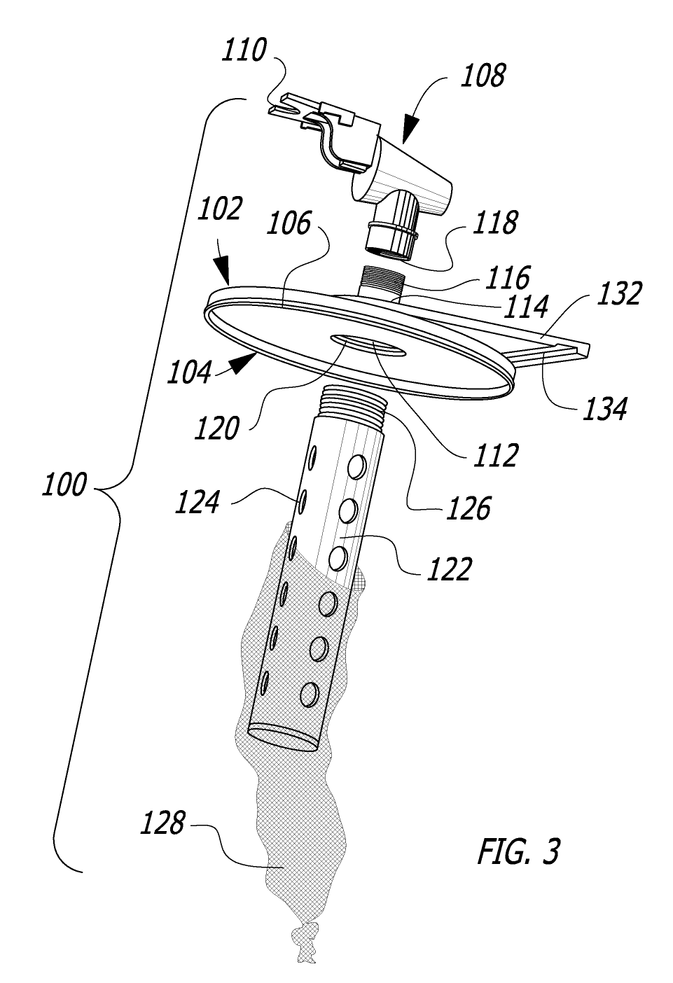

With reference now to FIGS. 3-5, the assembly 100 includes a lid 102 which is configured so as to be sealingly attached to an open end of the paint can 2. As such, the lid 102 of the assembly 100 is approximately the size of the original paint can lid. The lid 102 includes a peripheral rim 104 that is configured for interference fitting with a peripheral rim 4 of the paint can 2. Typically, the paint can's rim 4 includes an annular groove 6, as illustrated in FIG. 9, and the rim 104 of the assembly lid 102 has a projecting annular rib 106 which is configured for interference fit within the groove 6 so as to sealingly attach the assembly lid 102 to the peripheral rim 4 of the open end of the paint can 2. This friction fit connection forms a seal and prevents paint from leaking from the can 2 and attached assembly 100. It will be appreciated that when the paint can 2 has a different rim configuration, the rim 104 of the assembly lid 102 can have a corresponding mating configuration so as to form a sealed connection thereto.

As shown in FIGS. 1-5, a spigot 108 extends from the lid 102 so as to be in fluid communication with the paint within the paint can 2, and for controllably pouring the paint from the can 2. As illustrated, the spigot 108 includes a manually actuated lever 110 which is used to selectively open and close the spigot 108, such as by opening and closing a valve (not shown) within the spigot 108. It will be appreciated by those skilled in the art that other types of spigots 108 can be used, such as a push button spigot, wherein a button is selectively pushed so as to open flow through the spigot 108, and upon release of the button the flow is stopped.

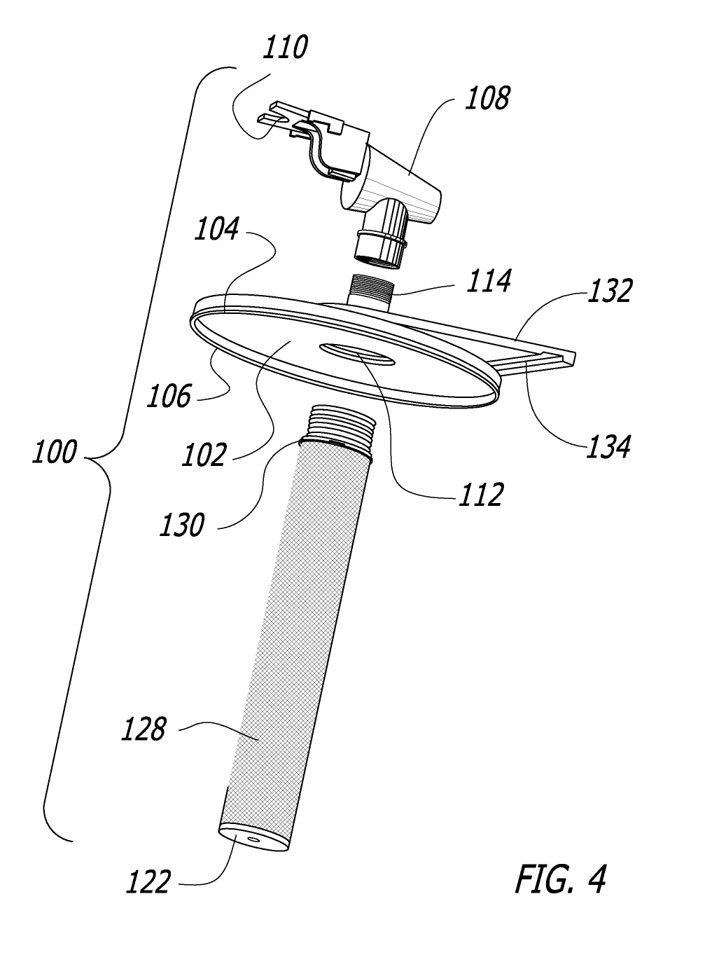

With reference to FIGS. 3 and 4, an aperture 112 is formed in the assembly lid 102 for permitting paint to flow from the can 2 to and through the spigot 108. Although the spigot 108 may be formed integrally with the lid 102, typically the spigot 108 is removably attached to the lid 102. This may be done in a variety of ways, including by means of extension 114, which may include external threads 116 for threaded connection to internal threads 118 of the spigot 108. Extension member 114 is hollow and extends from the lid aperture 112. The extension 114 may be formed integrally with the lid 102, or may be connected to the lid 102, such as by means of threaded connection with the internal threads 120 of the lid aperture 112. It will be understood that the spigot 108 could be directly threadedly connected to the threads 120 of the lid aperture 112 as well, and negate the need for the extension 114.

A filter is associated with the lid for filtering the paint before it passes through the spigot 108. In the embodiment of the invention illustrated in FIGS. 3-5, the filter includes a hollow body 122 which extends from the aperture 12 of the lid 102. The body 122 may be removably attachable to the lid 102, such as by means of threaded connection with threads 126 of the body 122 threadedly engaging threads 120 of the aperture 112 of the lid 102. Alternatively, the body 122 may be formed integrally with the lid 102. The body 122 is illustrated as an elongated cylinder in FIGS. 3-5. However, it will be appreciated that the body 122 may have other configurations which suit the needs of the invention.

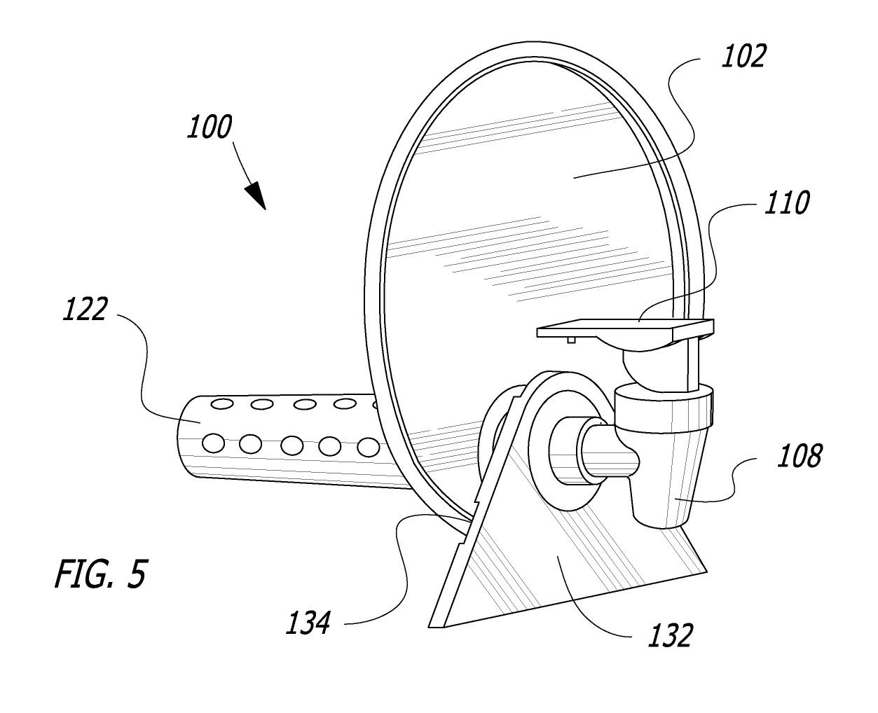

As can be seen in FIGS. 3 and 5, the body 122 includes a plurality of apertures 124 or is perforated. Such apertures or perforations 124 can serve to filter the paint alone. However, typically the assembly also includes a mesh material 128 at least partially surrounding the body 122. A mesh material 128, in the embodiment illustrated in FIGS. 1-5 can comprise a mesh sleeve, which can extend over the body 122 and be retained thereto, such as by means of a clip 130 or the like. A removable mesh material can be very useful in that the mesh material 128 can be removed for cleaning or even be discarded. Moreover, the porosity of the mesh material 128 may be selected by the fineness of the mesh material such that a relatively low porous mesh material may be used, for example, with paint stains, but a mesh material having a higher porosity or a less fine mesh material can be used for thicker paints.

As shown in FIGS. 1-5, the assembly 100 may include a support stand 132 which serves to prevent the paint can 2 and attached assembly 100 from rolling when placed on a generally flat surface, and also raising the spigot 108 to a desired height. The support stand 132 may be removably associated with the assembly 100, such as by being disposed between the spigot 108 and the lid 102. The support stand may include a cutout or a groove 134 which is sized and configured so as to be inserted over the peripheral edge of the lid 102 and the peripheral rim 104 of the paint can 2, so as to hold the support stand 132 in place and in relation to the paint can 2.

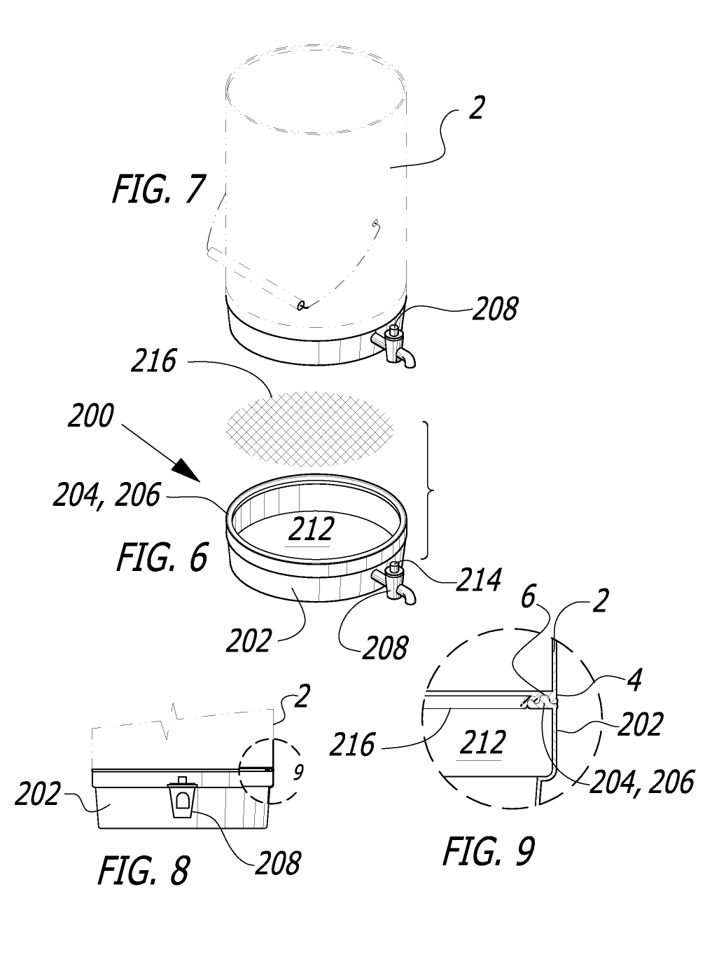

With reference now to FIGS. 6-9, another paint can dispenser assembly 200 embodying the present invention is shown. In this case, the lid 202 defines a base having a well 212. An upper rim 204 of the lid 202 includes a rib 206 for interference fit within the annular groove 6 of the rim 4 of the paint can 2, as illustrated in FIG. 9.

A spigot 208 extends through a side wall of the lid 202 so as to be in fluid communication with the paint within the well 212. As illustrated in FIGS. 6-8, the spigot 208 includes a push button 214 actuating mechanism to selectively open and close the spigot 208.

A sheet of mesh material 216 is associated with the lid 202, typically having an outer edge thereof captured between the rim of the paint can 4 and the rim 204 of the base lid 202, as illustrated in FIG. 9. In this manner, when the paint can is inverted, as illustrated in FIGS. 7 and 9, the paint will flow through the filter 216 and into the well 212 before passing through the spigot 208, and thus be filtered.

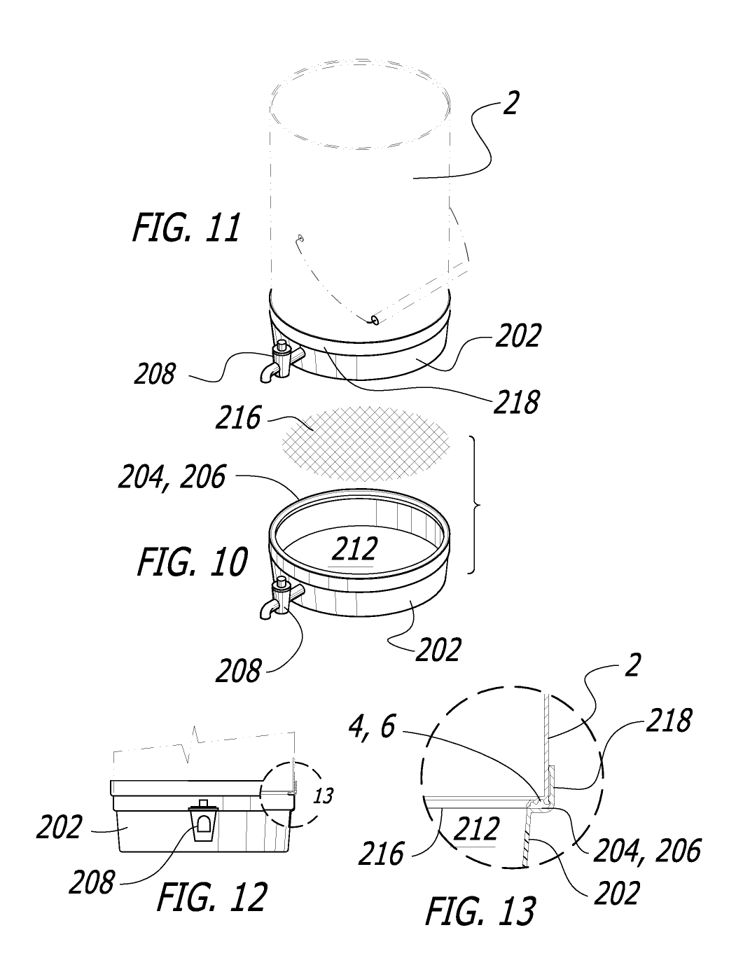

With reference now to FIGS. 10-13, a similar embodiment of the invention is shown, with similar components and features having the same reference numbers indicated above. However, in this embodiment, the lid 202 includes an extending lip 218 which is sized and configured so as to extend over a portion of the open end and wall of the paint can 2, as illustrated in FIGS. 11 and 13. This lip 218 serves to reinforce the interconnection of the lid 202 and the paint can 2, and prevent the paint can 2 from accidentally becoming dislodged from the lid 202, such as when being struck from the side, falling, etc.

It will be appreciated by those skilled in the art that the paint dispenser assembly of the present invention enables both homeowners and professionals to controllably dispense paint from a paint can using a manually actuated spigot, while filtering the paint of impurities which can adversely affect the appearance of the object being painted. Moreover, filtering the paint while dispensing the paint from the container enables the dispensed paint to be used in a pressurized sprayer without the concern of contaminants and other objects clogging the sprayer nozzles and lines. The assembly of the present invention can merely be attached to the existing paint can in place of the lid of the paint can, minimizing expense and rendering the assembly of the present invention easy to use.

Although several embodiments have been described in detail for purposes of illustration, various modifications may be made without departing from the scope and spirit of the invention. Accordingly, the invention is not to be limited, except as by the appended claims.

What is claimed is:

1. A paint can dispenser assembly, comprising:
a lid sealingly attachable to an open end of a paint can;
a spigot extending from the lid so as to be in fluid communication with paint within the paint can for controllably pouring the paint from the can; and
a filter associated with the lid for filtering the paint before it passes through the spigot.

2. The assembly of claim 1, wherein the lid includes a peripheral rim that interference fits with a peripheral rim of the paint can.

3. The assembly of claim 1, wherein the spigot comprises a manually actuated lever or push button for selectively opening and closing the spigot.

4. The assembly of claim 1, wherein the spigot is removably attached to the lid.

5. The assembly of claim 1, wherein the filter comprises an apertured hollow body extending from the lid generally opposite the spigot and into the paint can.

6. The assembly of claim 5, wherein the body is removably attached to the lid.

7. The assembly of claim 5, including a mesh material at least partially surrounding the body.

8. The assembly of claim 7, wherein the mesh material is removably attached to the body.

9. The assembly of claim 1, including a support for preventing the paint can dispenser assembly and attached paint can from rolling on a surface.

10. The assembly of claim 1, wherein a portion of the filter is captured between a rim of the lid and a rim of the paint can.

11. The assembly of claim 10, wherein the filter comprises a sheet of mesh material.

12. The assembly of claim 1, wherein the lid defines a base having a well in fluid communication with the spigot.

13. The assembly of claim 1, wherein the lid includes a lip that extends over an outer surface of the paint can adjacent to the open end thereof.

14. A paint can dispenser assembly, comprising:
a lid including a peripheral rim that interference fits with a peripheral rim of the paint can so as to sealingly attach the lid to an open end of a paint can;
a spigot extending from the lid so as to be in fluid communication with paint within the paint can and selectively opened and closed for controllably pouring the paint from the can; and
a filter comprising an apertured hollow body extending from the lid generally opposite the spigot and into the paint can, and a mesh material at least partially surrounding the body for filtering the paint before it passes through the spigot.

15. The assembly of claim 14, wherein the spigot includes a manually actuated lever or push button for selectively opening and closing the spigot for controllably pouring the paint from the can.

16. The assembly of claim 14, wherein the spigot is removably attached to the lid.

17. The assembly of claim 14, wherein the body is removably attached to the lid.

18. The assembly of claim 14, wherein the mesh material is removably attached to the body.

19. The assembly of claim 14, including a support for preventing the paint can dispenser assembly and attached paint can from rolling on a surface.

20. A paint can dispenser assembly, comprising:
a lid including a peripheral rim that interference fits with a peripheral rim of the paint can so as to sealingly attach the lid to an open end of a paint can;
a spigot extending from the lid so as to be in fluid communication with paint within the paint can and selectively opened and closed for controllably pouring the paint from the can; and
a filter having a portion thereof captured between the rim of the lid and the rim of the paint can for filtering the paint before it passes through the spigot.

21. The assembly of claim 20, wherein the filter comprises a sheet of mesh material.

22. The assembly of claim 20, wherein the spigot includes a manually actuated lever or push button for selectively opening and closing the spigot for controllably pouring the paint from the can.

23. The assembly of claim 20, wherein the lid defines a base having a well in fluid communication with the spigot.

24. The assembly of claim 20, wherein the lid includes a lip that extends over an outer surface of the paint can adjacent to the open end thereof.
